(19) United States
(12) Patent Application Publication
(10) Pub. No.: US 2021/0069570 A1
(43) Pub. Date: Mar. 11, 2021

(54) METHOD, ELECTRONIC DEVICE AND NON-TRANSITORY COMPUTER READABLE STORAGE MEDIUM FOR ESTABLISHING COURT INFORMATION

(71) Applicants: Hsin-Chieh Cheng, Taipei City (TW); Ching-Wen Sun, Taipei City (TW)

(72) Inventors: Hsin-Chieh Cheng, Taipei City (TW); Ching-Wen Sun, Taipei City (TW)

(73) Assignee: COMPAL ELECTRONICS, INC., Taipei City (TW)

(21) Appl. No.: 16/595,492

(22) Filed: Oct. 8, 2019

(30) Foreign Application Priority Data
Sep. 9, 2019 (TW) 108132410

(51) Int. Cl. A63B 71/06; A63B 71/04; A63B 69/00; G06F 9/54

(52) U.S. Cl. CPC A63B 71/06; A63B 71/04; A63B 69/0071; A63B 2243/0037; A63B 2220/40; A63B 2220/62; G06F 9/542

(57) ABSTRACT

A method for establishing court information is provided. The method includes: establishing connection with an external smart ball; providing a prompt message indicating to move the external smart ball from a first characteristic spot of a court to a second characteristic spot of the court; obtaining sensing information from the external smart ball after providing the prompt message; calculating a movement trajectory of the external smart ball according to the sensing information; and obtaining a direction of a line connecting the first characteristic spot and the second characteristic spot in a geomagnetic coordinate. An electronic device and a non-transitory computer readable storage medium using the method are also provided.

### CROSS-REFERENCE TO RELATED APPLICATION

This application claims the priority benefit of Taiwan application serial no. 108132410, filed on Sep. 9, 2019. The entirety of the above-mentioned patent application is hereby incorporated by reference herein and made a part of this specification.

### BACKGROUND

### 1. Technical Field

The disclosure relates to a method for establishing court information, and an electronic device and a non-transitory computer readable storage medium using the method.

### 2. Description of Related Art

Smart ball is a very important invention in recent years, which helps athletes adjust their postures through a scientific approach. Take basketball as an example, a smart basketball looks the same as a normal basketball but it is equipped with built-in nine-axis sensor, Bluetooth chip, and battery. The data of the nine-axis sensor is transmitted to an external electronic device so that the external electronic device can calculate the posture, angle, and strength when the player shoots a basketball and determine whether the shot will score or not for statistics. Analysis of such statistics allows athletes to understand their own strengths and weaknesses and improve themselves in training.

The court (or field) is also one of the important factors that affect the performance of the athletes. The home court advantage in basketball is a good example. In different courts, various environmental factors such as ground material and sunlight direction may influence the performance of the athletes. Therefore, the information of the court also plays an important part in the statistics of player performance.

### SUMMARY

The disclosure provides a court information establishing method, an electronic device, and a non-transitory computer readable storage medium for obtaining the positioning and direction of a court.

The court information establishing method of the disclosure is adapted for an electronic device. The court information establishing method includes: establishing connection with an external smart ball; providing a prompt message indicating to move the external smart ball from a first characteristic spot of a court to a second characteristic spot of the court; obtaining sensing information from the external smart ball after providing the prompt message; calculating a movement trajectory of the external smart ball according to the sensing information; and obtaining a direction of a line connecting the first characteristic spot and the second characteristic spot of the court in a geomagnetic coordinate.

The electronic device of the disclosure is adapted for establishing court information and includes a communication part, a prompting part, and a processor coupled to the communication part and the prompting part. The communication part establishes connection with an external smart ball and obtains sensing information from the external smart ball. The prompting part provides a prompt message, wherein the prompt message indicates to move the external smart ball from a first characteristic spot of a court to a second characteristic spot of the court. The processor calculates a movement trajectory of the external smart ball according to the sensing information to obtain a direction of a line connecting the first characteristic spot and the second characteristic spot of the court in a geomagnetic coordinate.

The non-transitory computer readable storage medium of the disclosure records a program, and the program is loaded via a computing device to perform the following: establishing connection with an external smart ball; providing a prompt message indicating to move the external smart ball from a first characteristic spot of a court to a second characteristic spot of the court; obtaining sensing information of the external smart ball after providing the prompt message; and calculating a movement trajectory of the external smart ball according to the sensing information to obtain a direction of a line connecting the first characteristic spot and the second characteristic spot of the court in a geomagnetic coordinate.

Based on the above, the court information establishing method and the electronic device of the disclosure first guide the user to move the external smart ball in a preset manner by using the prompt message, and then analyze the sensing information of the external smart ball to calculate the actual movement trajectory of the external smart ball. Furthermore, the court information establishing method and the electronic device of the disclosure map the actual movement trajectory of the external smart ball to the preset movement of the external smart ball to obtain the information of the court.

In order to make the aforementioned and other features and advantages of the disclosure more comprehensible, embodiments accompanied with drawings are described in detail below.

### BRIEF DESCRIPTION OF THE DRAWINGS

FIG. 1 is a schematic block diagram of an electronic device according to an embodiment of the disclosure.

FIG. 2 is a flow chart of a court information establishing method according to an embodiment of the disclosure.

FIG. 3 is a flow chart of obtaining a direction of a line connecting a first characteristic spot and a second characteristic spot of a court in a geomagnetic coordinate according to an embodiment of the disclosure.

FIG. 4 is a schematic diagram of a prompt message according to an embodiment of the disclosure.

FIG. 5 is a schematic diagram of acceleration and acceleration information according to an embodiment of the disclosure.

FIG. 6 is a schematic diagram of an angle between a projection of a movement trajectory and the geomagnetic north according to an embodiment of the disclosure.

### DESCRIPTION OF THE EMBODIMENTS

The embodiments of the disclosure introduce a method for establishing court information and an electronic device. In addition to the positioning of a court, the court information establishing method according to the embodiments of the disclosure can also establish more detailed court information. For convenience, a basketball court will be described in the following embodiments as an example. Nevertheless, the disclosure is not limited thereto. According to the requirements in use, the court information establishing method described in the embodiments of the disclosure may also be used to establish the court information of various courts (or fields) such as a baseball field, a volleyball court, and a tennis court.

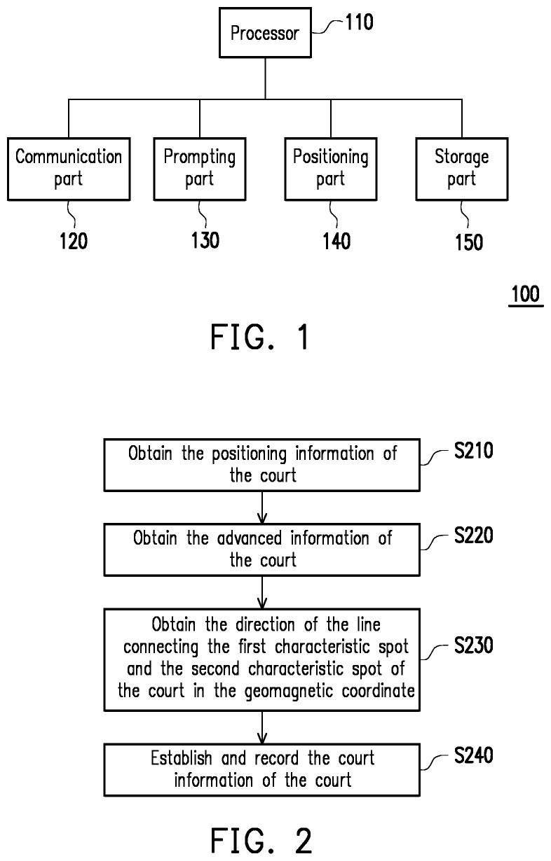

FIG. 1 is a schematic block diagram of an electronic device according to an embodiment of the disclosure.

Referring to FIG. 1, the electronic device 100 includes a processor 110, a communication part 120, a prompting part 130, a positioning part 140, and a storage part 150. The communication part 120, the prompting part 130, the positioning part 140, and the storage part 150 are all coupled to the processor 110. In the present embodiment, the electronic device 100 is, for example, a smart phone, but the disclosure is not limited thereto. In other embodiments, the electronic device 100 may be a mobile device such as a Personal Digital Assistant (PDA), a laptop, and a tablet, but not limited thereto.

In the present embodiment, the processor 110 is configured to control the overall operation of the electronic device 100 so as to perform the court information establishing method. The processor 110 is, for example, a general purpose processor, a special purpose processor, a conventional processor, a digital signal processor, a plurality of microprocessors, one or more microprocessors, controllers, or microcontrollers combined with a digital signal processor core, an Application Specific Integrated Circuit (ASIC), a Field Programmable Gate Array (FPGA), any other type of integrated circuit, a state machine, a processor based on Advanced RISC Machine (ARM), or the like, but not limited thereto.

In the present embodiment, the communication part 120 is configured to establish connection with an external smart ball. The communication part 120 supports, for example, Global System for Mobile Communication (GSM), Personal Handy-phone System (PHS), Code Division Multiple Access (CDMA) system, Wideband Code Division Multiple Access (WCDMA) system, Long Term Evolution (LTE) system, Worldwide interoperability for Microwave Access (WiMAX) system, Wireless Fidelity (Wi-Fi) system, LoRa wireless transmission technology, Bluetooth, components for signal transmission by any other means, or a combination thereof, but not limited thereto. In an embodiment, in addition to establishing connection with the smart ball, the communication part 120 may be further connected to a remote server to access data from the remote server.

In the present embodiment, the prompting part 130 is configured to provide a prompt message to the user and is, for example, a display screen of a smart phone, but the disclosure is not limited thereto. In other embodiments, the prompting part 130 may be any component that can be used to prompt the user, such as a computer screen and a speaker.

In the present embodiment, the positioning part 140 is configured to obtain the positioning of the electronic device 100 and is, for example, a global positioning system (GPS), but the disclosure is not limited thereto. In other embodiments, the positioning part 140 may be an Assisted Global Positioning System (AGPS), a GLONASS System, a BeiDou Navigation Satellite System, a Galileo Positioning System, or other communication positioning systems that perform positioning by a Global System for Mobile Communication (GSM) system, a Personal Handy-phone system (PHS), a Code Division Multiple Access (CDMA) system, a Wireless Fidelity (Wi-Fi) system, a Worldwide Interoperability for Microwave Access (WiMAX) system, a Radio Repeater, or a Radio Broadcaster. In addition, the positioning part 140 may be a communication positioning system that performs positioning by Bluetooth, Beacon, or an IP address, but not limited thereto.

In the present embodiment, the storage part 150 is configured to record data of any form or content. The storage part 150 may be a Random Access Memory (RAM), a Read-Only Memory (ROM), a flash memory, a Compact Flash (CF) memory card, a Secure Digital (SD) memory card, a micro SD memory card, a Memory Stick (MS), a Hard Disk Drive (HDD), or other similar devices. In the present embodiment, the storage part 150 of the electronic device 100 stores a plurality of code segments, which are executed by the processor 110 after being installed. For example, the code segments are an application for establishing court information, and the processor 110 executes the application to complete the court information establishing method according to the embodiment of the disclosure.

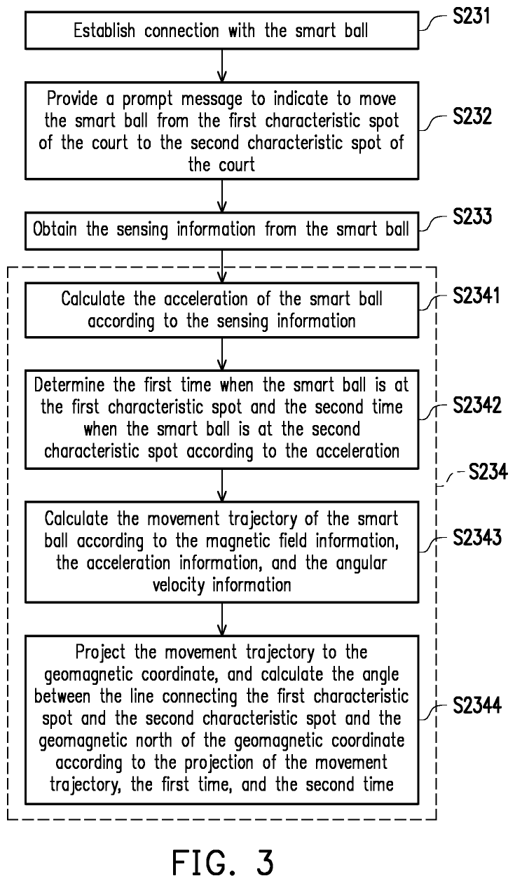

FIG. 2 is a flow chart of the court information establishing method according to an embodiment of the disclosure.

Referring to FIG. 2, the court information establishing method according to the present embodiment is adapted for the electronic device 100 described in the embodiment of FIG. 1. Therefore, the court information establishing method of the present embodiment will be described below with reference to the parts of the electronic device 100.

In Step S210, the processor 110 obtains the positioning information of the court. In the present embodiment, the user of the electronic device 100 carries the electronic device 100 to a specific basketball court to establish the court information of the basketball court. At this time, the positioning information (for example, latitude and longitude information) that the processor 110 obtains via the positioning part 140 may represent the positioning information of the court (for example, the basketball court).

In Step S220, the processor 110 obtains advanced information of the court. In the present embodiment, the processor 110 connects to an external server (for example, Google Map or other servers that can search for data by latitude and longitude) via the communication part 120 and uses the positioning information of the court for search in the external server. If the external server records the advanced information (for example, available court-related information such as court name, court address, court phone number, court opening time, and court number) of the court corresponding to the positioning information, the external server then transmits the advanced information of the court back to the electronic device 100.

In Step S230, the processor 110 obtains a direction of a line connecting a first characteristic spot and a second characteristic spot of the court in a geomagnetic coordinate. In the present embodiment, the electronic device 100 uses a nine-axis sensor built in the smart ball to obtain the direction of the line connecting the first characteristic spot and the second characteristic spot of the court in the geomagnetic coordinate.

FIG. 3 is a flow chart of obtaining the direction of the line connecting the first characteristic spot and the second characteristic spot of the court in the geomagnetic coordinate according to an embodiment of the disclosure.

Referring to FIG. 3, first, in Step S231, the electronic device 100 establishes connection with the smart ball. In the present embodiment, the user carries the electronic device 100 and a smart basketball to the basketball court, and the smart ball includes a communication part and a nine-axis sensor. The nine-axis sensor includes a three-axis magnetic field sensor, a three-axis acceleration sensor, and a three-axis angular velocity sensor.

In Step S232, the electronic device 100 provides a prompt message indicating to move the smart ball from the first characteristic spot of the court to the second characteristic spot of the court. Specifically, the characteristic spot of the court refers to a specific point in the court. Take baseball field as an example, the pitcher's mound, the home plate, and the base bags may all serve as characteristic spots of a baseball field. Take basketball court as an example, the court center, the left and right ends of the free-throw line, the center of the free-throw line, the center of the backboard, the left and right ends of the base line, and the center of the base line may all serve as characteristic spots of a basketball court. Take soccer field as an example, the 6-yard box before the goal line, the 12-yard penalty spot, and the 18-yard penalty arc may all serve as characteristic spots of a soccer field.

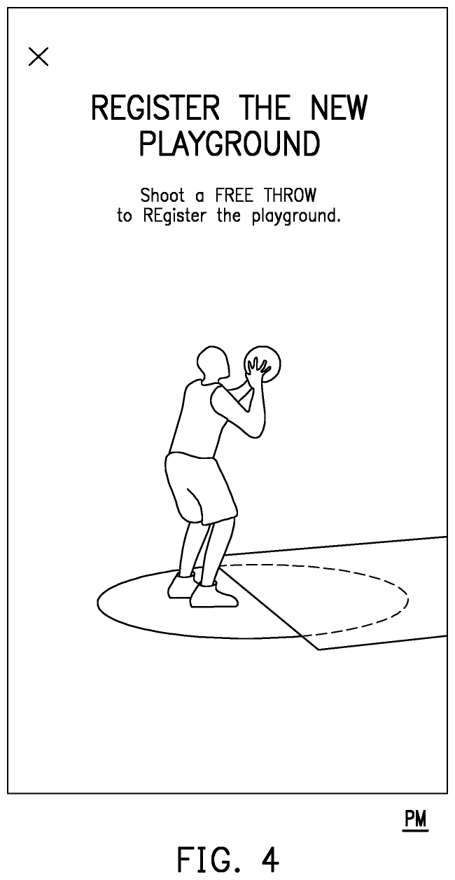

In the present embodiment, as shown in FIG. 4, the electronic device 100 provides a prompt message PM for establishing court information on a display screen and requests the user to stand at the center of the free-throw line and shoot the basketball. In other words, the prompt message PM indicates to move the smart basketball from the center of the free-throw line (first characteristic spot) to the basket (second characteristic spot). Thus, the electronic device 100 only needs to calculate the movement trajectory of the smart basketball after the user shoots the smart basketball to determine the direction of the line from the center of the free-throw line to the basket in the basketball court.

Subsequently, in Step S233, the electronic device 100 obtains sensing information from the smart ball. In the present embodiment, the electronic device 100 obtains magnetic field information, acceleration information, and angular velocity information sensed by the nine-axis sensor of the smart ball.

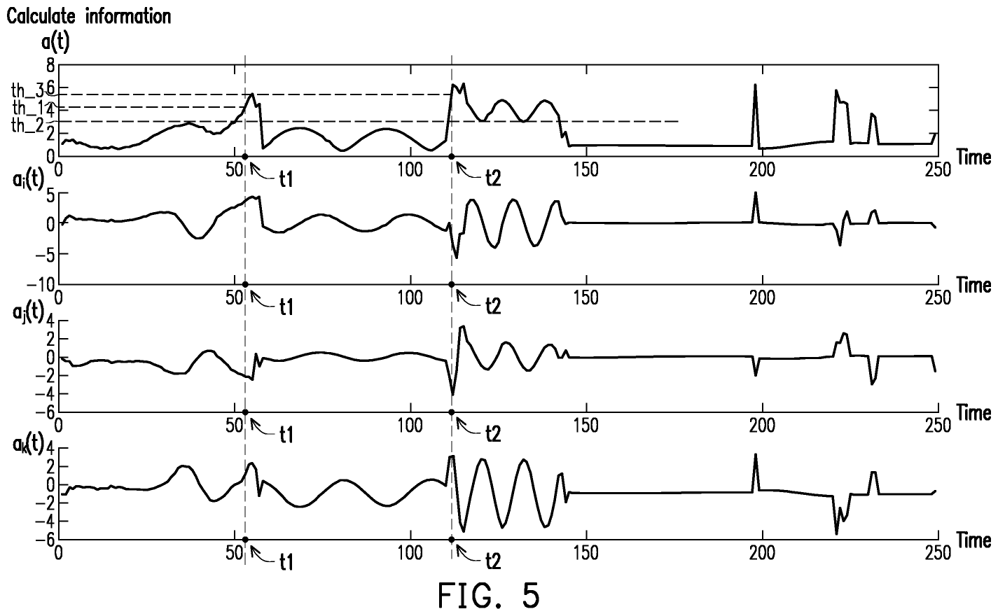

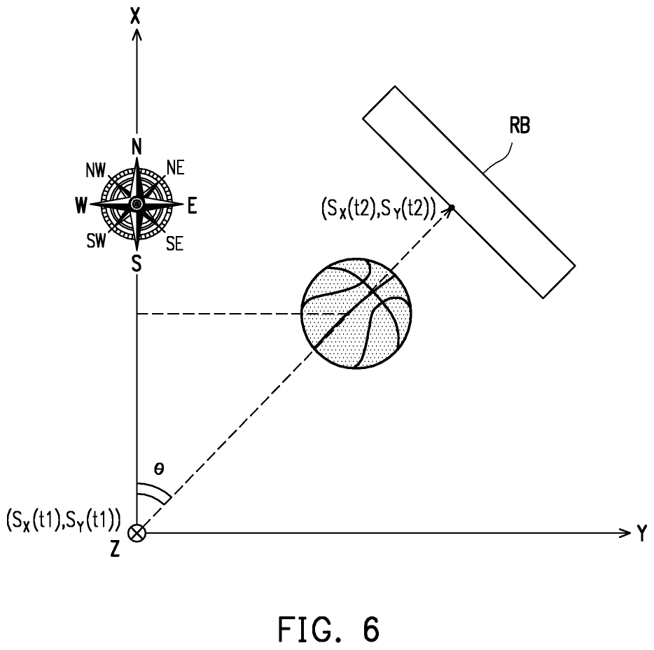

In Step S234, the electronic device 100 calculates the movement trajectory of the smart ball according to the obtained sensing information to obtain the direction of the line connecting the first characteristic spot and the second characteristic spot of the court in the geomagnetic coordinate. To be more specific, Step S234 further includes Step S2341 to Step S2344, which will be described below with reference with FIG. 5 and FIG. 6.

FIG. 5 is a schematic diagram of acceleration and acceleration information according to an embodiment of the disclosure and FIG. 6 is a schematic diagram of an angle between a projection of the movement trajectory and the geomagnetic north according to an embodiment of the disclosure.

In Step S2341, the processor 110 calculates the acceleration of the smart ball according to the sensing information. Referring to FIG. 5, the acceleration information of the sensing information includes the first axis acceleration aᵢ(t) at a plurality of times, the second axis acceleration aⱼ(t) at a plurality of times, and the third axis acceleration aₖ(t) at a plurality of times. In the present embodiment, the processor 110 calculates the acceleration a(t) of the smart ball at each time according to the accelerations aᵢ(t), aⱼ(t), and aₖ(t) of mutually orthogonal three axes.

In Step S2342, the processor 110 determines a first time t1 when the smart ball is at the first characteristic spot and a second time t2 when the smart ball is at the second characteristic spot according to the acceleration. Theoretically, when shooting or kicking, the user applies an external force to the smart ball so that the smart ball in a still state gains an initial speed; after being shot, the smart ball receives only gravity during the flight; and when the smart ball hits the backboard or the basket, the backboard or the basket also applies an external force to the smart ball to change the speed and direction of the smart ball. Therefore, before the smart ball is shot and when the smart ball hits the backboard or the basket, the smart ball has greater acceleration than during the flight. According to the acceleration sensed by the smart ball, the processor 110 determines the start time (the time of shooting), the movement time, and the end time (the time of hit) of the smart ball, and the start time may be regarded as the first time t1 when the smart ball is at the first characteristic spot and the end time may be regarded as the second time t2 when the smart ball is at the second characteristic spot, but the disclosure is not limited thereto. In some embodiments, the processor 110 may take a time following the start time as the first time t1, and take the end time or a time preceding the end time as the second time t2. In addition, the time when the smart ball passes through the basket, passes through the net, hits the goal gate, or hits the goal net may be taken as the end time.

In the present embodiment, the processor 110 sets, for example, a first threshold th_1 for determining the time of shooting, a second threshold th_2 for determining the movement time, and a third threshold th_3 for determining the end time. The second threshold th_2 is greater than zero and less than the first threshold th_1 and the third threshold th_3. However, the disclosure does not limit the three thresholds th_1, th_2, and th_3 to specific values, and those skilled in the art may set the values as required.

After providing the prompt message, the processor 110 starts to determine if the acceleration is greater than the first threshold th_1. The processor 110 takes the time when the acceleration first becomes greater than the first threshold, calculated from the time when the prompt message is provided, as the first time t1, and takes the acceleration at the time as the first acceleration. Then, the acceleration becomes less than the second threshold th_2 in the movement times, and the acceleration at these movement times is taken as the second acceleration. Next, after the movement times, the processor 110 takes the time when the acceleration first becomes greater than the third threshold th_3 as the second time t2, and takes the acceleration at the time as the third acceleration. In other words, the first acceleration is, for example, the acceleration of the smart ball when the smart ball is shot or kicked, and the first time t1 is, for example, the time when the smart ball is shot or kicked; the second acceleration is, for example, the acceleration of the smart ball when the smart ball moves or flies; and the third acceleration is, for example, the acceleration of the smart ball when the smart ball hits the backboard, hits the basket, passes through the basket, passes through the net, hits the goal gate, or hits the goal net, and the second time t2 is, for example, the time when the smart ball hits the backboard, hits the basket, passes through the basket, passes through the net, hits the goal gate, or hits the goal net. In some embodiments, to reduce erroneous determination, the processor 110 may set a preset number, and determine if the acceleration is greater than the third threshold th_3 to determine the second time t2 only when the total number of the movement times is greater than the preset number.

After obtaining the first time t1 when the smart ball is at the first characteristic spot and the second time t2 when the smart ball is at the second characteristic spot, in Step S2343, the processor 110 calculates the movement trajectory of the smart ball in the first time t1 and the second time t2 according to the magnetic field information, the acceleration information, and the angular velocity information.

To be more specific, the (i, j, k) coordinate system used in the acceleration information of the sensing information is based on the direction in which the acceleration sensor is installed in the smart ball. When the smart ball is not rotated, the trajectory function of the centroid of the smart ball in the three-dimensional magnetic field coordinates (X, Y, Z) can be calculated according to the acceleration information in combination with the magnetic field information; and when the smart ball is rotated, the trajectory function of the centroid of the smart ball in the three-dimensional magnetic field coordinates (X, Y, Z) is calculated according to the magnetic field information, the acceleration information, and the angular velocity information.

In the present embodiment, the processor 110 may, for example, first convert the acceleration information and the angular velocity information into the three-dimensional magnetic field coordinates (X, Y, Z), and then use the angular velocity information to correct the acceleration information to the three axis accelerations a_{X}(t), a_{Y}(t), and a_{Z}(t) of the centroid of the smart ball. Then, the three axis accelerations may be integrated twice, for example, by the following equations (1), (2), and (3) respectively to obtain the movement trajectories S_{X}(t), S_{Y}(t), and S_{Z}(t).

S_{X}(t)=∫∫ a_{X}(t)d² t (1)

S_{Y}(t)=∫∫ a_{Y}(t)d² t (2)

S_{Z}(t)=∫∫ a_{Z}(t)d² t (3)

The upper and lower limits of the integration are, for example, the first time t1 and the second time t2.

In Step S2344, the processor 110 projects the movement trajectories S_{X}(t), S_{Y}(t), and S_{Z}(t) to the geomagnetic coordinate, and according to the projections of the movement trajectories, the first time t1, and the second time t2, calculates the angle between the line connecting the first characteristic spot and the second characteristic spot and the geomagnetic north of the geomagnetic coordinate. In the present embodiment, the X axis of the three-dimensional magnetic field coordinates is, for example, directed to the geomagnetic north of the geomagnetic coordinate, and the Y axis of the three-dimensional magnetic field coordinates is, for example, directed to the geomagnetic east of the geomagnetic coordinate. Therefore, the movement trajectories S_{X}(t) and S_{Y}(t) may be used to represent the projections of the movement trajectories S_{X}(t), S_{Y}(t), and S_{Z}(t) in the geomagnetic coordinate.

Referring to FIG. 6, the first time t1 is substituted into the movement trajectories S_{X}(t) and S_{Y}(t) to define the position (S_{X}(t1), S_{Y}(t1)) of the first characteristic spot, and the second time t2 is substituted into the movement trajectories S_{X}(t) and S_{Y}(t) to define the position (S_{X}(t2), S_{Y}(t2)) of the second characteristic spot. Therefore, the angle θ between the line connecting the first characteristic spot and the second characteristic spot and the geomagnetic north in the geomagnetic coordinate may be obtained by the following equation (4).

$$θ = {tan}^{- 1} \frac{{S}_{Y} ( t 2 ) - {S}_{Y} ( t 1 )}{{S}_{X} ( t 2 ) - {S}_{X} ( t 1 )} \times \frac{180}{π} \qquad ( 4 )$$

In the present embodiment, the direction of the line connecting the center of the free-throw line (that is, the first characteristic spot) and the center of the basket or the backboard RB (that is, the second characteristic spot) is equivalent to the long axis direction of the basketball court. Therefore, by performing Step S230, the electronic device 100 obtains the long axis direction of the basketball court (for example, the angle between the long axis and the geomagnetic north).

It is worth mentioning that although the electronic device 100 obtains the positioning information of the court, the advanced information, and the direction of the line connecting the first characteristic spot and the second characteristic spot in the geomagnetic coordinate in Steps S210, S220, and S230 respectively, the above information is not necessarily obtained in this order. For example, the electronic device 100 may first perform Step S230 and then perform Step S210 and Step S220, which also allows the electronic device 100 to obtain the positioning information of the court, the advanced information, and the direction of the line connecting the first characteristic spot and the second characteristic spot in the geomagnetic coordinate.

In some embodiments, the electronic device 100 may provide a prompt message PM requesting the user to stand at the center of the free-throw line to shoot the basketball, and then provide an input interface for the user to input the position where the smart basketball falls, so as to prevent inaccurate calculation if the smart basketball deviates too far from the basket. To be more specific, the input interface is, for example, to divide the backboard into a plurality of areas for the user to select the area that the smart basketball hits. After the user selects one of the backboard areas, the processor 110 may correct the long axis direction of the basketball court calculated in Step S230 accordingly.

For example, the input interface divides the backboard into three areas (left, center, and right areas), and respectively defines a compensation angle θ_{C} for the left area (for example, +8° but not limited thereto), a compensation angle θ_{C} for the center area (for example, 0° but not limited thereto), and a compensation angle θ_{C} for the right area (for example, −8° but not limited thereto). Take FIG. 6 as an example, if the user selects the center area in the input interface, the corresponding compensation angle θ_{C} is 0°, and therefore, the angle between the line connecting the first characteristic spot and the second characteristic spot and the geomagnetic north in the geomagnetic coordinate may be represented by θ in the equation (4) as described in the preceding paragraphs; and if the user selects the left or right area in the input interface, after the angle between the line connecting the first characteristic spot and the second characteristic spot and the geomagnetic north in the geomagnetic coordinate is calculated by the equation (4), the corresponding compensation angle θ_{C} needs to be added, and therefore, the angle between the line connecting the first characteristic spot and the second characteristic spot and the geomagnetic north in the geomagnetic coordinate becomes θ+θ_{C}.

Finally, in Step S240, the processor 110 establishes and records the court information. Specifically, the court information includes the positioning information of the court, the advanced information, and the direction of the line connecting the first characteristic spot and the second characteristic spot of the court in the geomagnetic coordinate. In the present embodiment, the processor 110 records the advanced information of the court (for example, name and address), the positioning information of the court (for example, latitude and longitude), and the direction of the line connecting the first characteristic spot and the second characteristic spot of the court in the geomagnetic coordinate (for example, the angle between the long axis and the geomagnetic north) in the storage part 150 to complete establishment of the court information.

In addition, the disclosure further provides a non-transitory computer readable storage medium in which a computer program is recorded. The computer program is configured to perform the steps of the court information establishing method described above. The computer program includes a plurality of code segments. In addition, the steps of the court information establishing method can be performed after the code segments are loaded into the electronic device and executed.

In conclusion, the court information establishing method and the electronic device according to the embodiments of the disclosure first guide the user to move the smart ball in a preset manner by using the prompt message, and then analyze the sensing information of the smart ball to calculate the actual movement trajectory of the smart ball. Thus, the information of the court is obtained simply by mapping the actual movement trajectory of the smart ball to the preset movement of the smart ball.

Although the disclosure has been described above with reference to the foregoing embodiments, they are not intended to limit the disclosure. It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A court information establishing method adapted for an electronic device, the court information establishing method comprising:
establishing connection with an external smart ball;
providing a prompt message indicating to move the external smart ball from a first characteristic spot of a court to a second characteristic spot of the court;
obtaining sensing information from the external smart ball after providing the prompt message;
calculating a movement trajectory of the external smart ball according to the sensing information; and
obtaining a direction of a line connecting the first characteristic spot and the second characteristic spot of the court in a geomagnetic coordinate.

2. The court information establishing method according to claim 1, wherein the sensing information comprises magnetic field information, acceleration information, and angular velocity information.

3. The court information establishing method according to claim 1, wherein calculating the movement trajectory of the external smart ball according to the sensing information comprises:
calculating acceleration of the external smart ball according to the sensing information;
determining a first time when the external smart ball is at the first characteristic spot and a second time when the external smart ball is at the second characteristic spot according to the acceleration; and
calculating the movement trajectory of the external smart ball according to the acceleration, the first time, and the second time.

4. The court information establishing method according to claim 1, wherein obtaining the direction of the line connecting the first characteristic spot and the second characteristic spot of the court in the geomagnetic coordinate comprises:
projecting the movement trajectory to the geomagnetic coordinate; and
calculating an angle between the line connecting the first characteristic spot and the second characteristic spot and a geomagnetic north of the geomagnetic coordinate according to a projection of the movement trajectory.

5. The court information establishing method according to claim 3, wherein determining the first time when the external smart ball is at the first characteristic spot and the second time when the external smart ball is at the second characteristic spot according to the acceleration comprises:
determining a start time, a plurality of movement times, and an end time of the external smart ball according to the acceleration.

6. The court information establishing method according to claim 5, wherein calculating the movement trajectory of the external smart ball according to the acceleration, the first time, and the second time comprises:
taking the start time as the first time and taking the end time as the second time.

7. The court information establishing method according to claim 5, wherein calculating the movement trajectory of the external smart ball according to the acceleration, the first time, and the second time comprises:
taking a time following the start time as the first time and taking the end time as the second time.

8. The court information establishing method according to claim 5, wherein calculating the movement trajectory of the external smart ball according to the acceleration, the first time, and the second time comprises:
taking a time following the start time as the first time and taking a time preceding the end time as the second time.

9. The court information establishing method according to claim 5, wherein the acceleration is greater than a first threshold at the start time, the acceleration is less than a second threshold at the movement times, and the acceleration is greater than a third threshold at the end time.

10. The court information establishing method according to claim 9, wherein the second threshold is greater than the first threshold, and the third threshold is greater than or equal to the second threshold.

11. The court information establishing method according to claim 1, further comprising:
obtaining positioning information of the court; and
establishing and recording court information of the court,
wherein the court information comprises the positioning information of the court, and the direction of the line connecting the first characteristic spot and the second characteristic spot in the geomagnetic coordinate.

12. The court information establishing method according to claim 11, further comprising:
obtaining advanced information of the court from an external server according to the positioning information,
wherein the court information further comprises the advanced information of the court.

13. An electronic device adapted for establishing court information, the electronic device comprising:
a communication part establishing connection with an external smart ball and obtaining sensing information from the external smart ball;
a prompting part providing a prompt message, wherein the prompt message indicates to move the external smart ball from a first characteristic spot of a court to a second characteristic spot of the court; and
a processor coupled to the communication part and the prompting part and calculating a movement trajectory of the external smart ball according to the sensing information to obtain a direction of a line connecting the first characteristic spot and the second characteristic spot of the court in a geomagnetic coordinate.

14. The electronic device according to claim 13, further comprising:
a positioning part coupled to the processor and obtaining positioning information of the court; and
a storage part coupled to the processor and recording data,
wherein the processor further establishes the court information of the court and records the court information in the storage part, wherein the court information comprises the positioning information of the court and the direction of the line connecting the first characteristic spot and the second characteristic spot in the geomagnetic coordinate.

15. The electronic device according to claim 14, wherein the communication part is further connected to an external server, and the processor further obtains advanced information of the court from the external server via the communication part according to the positioning information,
wherein the court information further comprises the advanced information of the court.

16. A non-transitory computer readable storage medium recording a program, wherein the program is loaded via a computing device to perform:
establishing connection with an external smart ball;
providing a prompt message indicating to move the external smart ball from a first characteristic spot of a court to a second characteristic spot of the court;
obtaining sensing information of the external smart ball after providing the prompt message; and
calculating a movement trajectory of the external smart ball according to the sensing information to obtain a direction of a line connecting the first characteristic spot and the second characteristic spot of the court in a geomagnetic coordinate.
